(19) United States
(12) Patent Application Publication
(10) Pub. No.: US 2005/0011462 A1
(43) Pub. Date: Jan. 20, 2005

(54) Salt block support

(76) Inventor: Ernest C. Wilson, Red Oak, TX (US)

Correspondence Address: Stephen R. Greiner, Esquire;GREINER LAW OFFICES, P.C., Suite 110, 6701 Democracy Blvd., Bethesda, MD, 20817, US

(21) Appl. No.: 10/609,810

(22) Filed: Jul. 1, 2003

(51) Int. Cl. A01K 5/015

(52) U.S. Cl. 119/51.03

(57) ABSTRACT

A support for isolating a salt block from vermin and ground moisture. The support includes a tray for carrying a salt block. A rod extends from the tray. A clamp, adapted for attachment to a post, is secured to the distal end of the rod so as to rotate relative to the tray.

### FIELD OF THE INVENTION

The present invention relates generally to animal feeding devices and, more specifically, to solid or lick feeders.

### BACKGROUND OF THE INVENTION

Animals, like humans, require a wide variety of vitamins and minerals in their diets to stay healthy and grow. In some areas, these items are difficult for animals to find. To combat this problem and to lure wild game, many farmers, ranchers, conservationists and hunters set salt blocks enriched with vitamins outside for animals, particularly deer and cattle, to consume. Initially, the blocks were placed directly on the ground or close to ground level. This, unfortunately, lead to rapid degradation of the blocks in standing water and rapid consumption by vermin.

Over time, devices were developed to hold the salt blocks for animals above the ground, but these devices have many limitations. For example, some of the devices cannot be attached to fence posts or other vertical supports. Other devices can be attached to vertical supports like fence posts, but not angled supports such as those found on deer feeders and tree stands. If an angled support is used, the rigid coupling between the mount and the usual block-supporting tray causes the block to fall to the ground. In brief, the latter devices do not permit the block-supporting tray to be adjusted independently from the mount. Thus, there exists a need for a simple, effective, and inexpensive device for supporting a salt block above ground level and in a horizontal position, even when the device is attached to an angled support.

### SUMMARY OF THE INVENTION

In light of the problems associated with supporting a salt block for consumption by large animals, yet excluding small animals and vermin, it is a principal object of the invention to provide a device that can hold a salt block at a set height above the ground and at a level orientation regardless of the incline of the support to which the device is attached. Thus, the device can be used with vertical supports such as fence posts and inclined supports like those of deer feeders.

It is another object of the invention to provide a salt block support of the type described that can be firmly attached to a columnar support or post having virtually any cross-sectional configuration. Square and round posts, for example, are clamped with equal strength.

It is an object of the invention to provide improved elements and arrangements thereof in a salt block support for the purposes described which is lightweight, portable, rugged, inexpensive to manufacture and dependable in use.

Briefly, the salt block support in accordance with this invention achieves the intended objects by featuring a tray for carrying a salt block. The tray has an internally threaded socket member from which a threaded rod extends. The rod has a longitudinal axis and a distal end remote from the tray. A clamp, adapted for attachment to a post, is carried at the distal end of said threaded rod. The clamp has a second internally threaded socket member for threadably receiving the distal end of the threaded rod such that the clamp can rotate about the longitudinal axis relative to the tray.

The forgoing and other objects, features and advantages of the present invention will become readily apparent upon further review of the following detailed description of the preferred embodiment as illustrated in the accompanying drawings.

### BRIEF DESCRIPTION OF THE DRAWINGS

The present invention may be more readily described with reference to the accompanying drawings, in which:

FIG. 1 is a side view of a salt block support in accordance with the present invention.

FIG. 2 is a rear view of the salt block support of FIG. 1.

FIG. 3 is a top view of the salt block support.

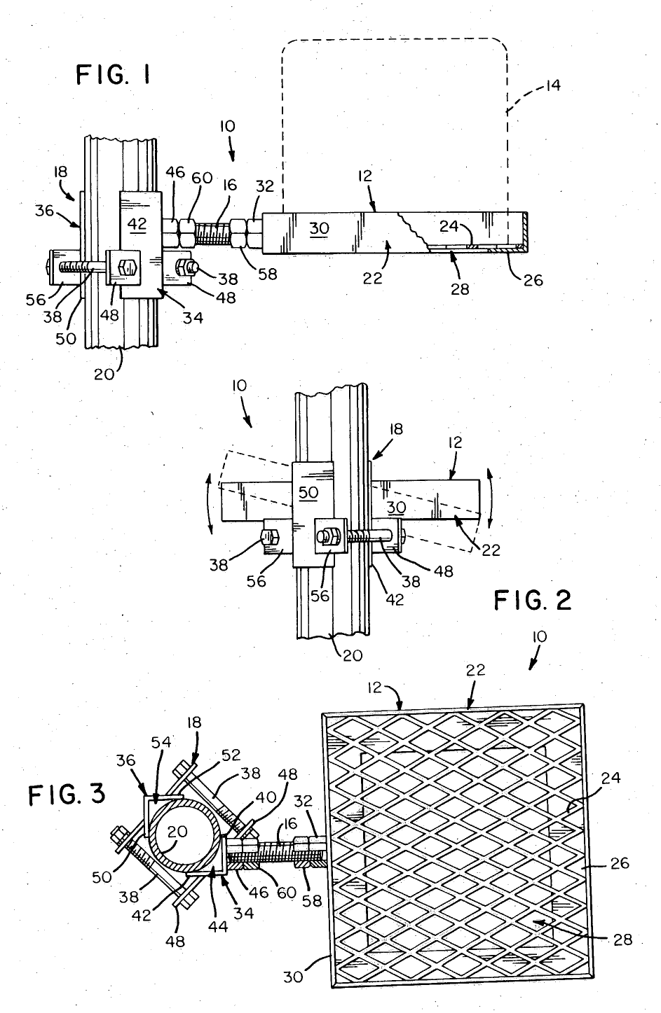

Similar reference characters denote corresponding features consistently throughout the accompanying drawings.

### DETAILED DESCRIPTION OF THE PREFERRED EMBODIMENT

Referring now to the FIGS., a salt block support in accordance with the present invention is shown at 10. Support 10 includes a tray 12 adapted to carry a salt block 14. Extending from one side of tray 12 is a threaded rod 16 rotatably bearing a clamp 18 for engaging a post 20. The rotatable attachment of clamp 18 to tray 12 permits tray 12 to be leveled regardless of the incline of post 20.

Tray 12 has a rectangular frame 22 that receives, carries, and reinforces a perforated panel 24. Frame 22 is provided with a planar bottom wall 26 with a central opening 28 and a side wall 30 extending upwardly from the periphery of bottom wall 26. Frame 22 may be formed by welding a plurality of short pieces of angle iron together. Perforated panel 24 rests upon bottom wall 26, to which it is welded, and covers opening 28 so as to prevent the passage of salt block 14 through opening 28. Preferably, perforated panel 24 is formed of expanded metal mesh that is durable and permits water and other debris to fall through opening 28 and to the ground instead of collecting around salt block 14 damaging it.

An internally threaded socket member 32 is secured to one side of frame 22, i.e., welded to side wall 30. Rod 16 is threadably engaged with socket member 32 and extends outwardly therefrom. At the distal end of rod 16, remote from socket member 32, is carried clamp 18.

Clamp 18 includes a pair of L-shaped brackets 34 and 36 formed of angle iron and held in opposition to one another by a pair of threaded fasteners 38. As shown, bracket 34 has a transverse wall 40 and a longitudinal wall 42 oriented at right angles so as to form a channel 44 therebetween for receiving post 20. An internally threaded socket member 46 is welded to transverse wall 40 for threadably receiving the distal end of rod 16. Beneath socket member 46, a pair of apertured flanges 48 extends outwardly from bracket 34 with one flange 48 extending from transverse wall 40 and another flange 48 extending from longitudinal wall 42. Similarly, bracket 36 has a transverse wall 50 and a longitudinal wall 52 oriented at right angles to one another and defining a post-receiving channel 54 therebetween. A pair of apertured flanges 56 extends outwardly from bracket 36 in registry with flanges 48 with one flange 56 extending from transverse wall 50 and another flange 56 extending from longitudinal wall 52. Fasteners 38 pass through flanges 48 and 56 to adjustably join brackets 34 and 36 together.

A pair of lock nuts 58 and 60 is threaded onto rod 16 to permit the angular orientation of both tray 12 and clamp 18 with respect to rod 16 to be fixed. (It should also be appreciated that lock nuts 58 and 60 accommodate the use of rod 16 which is removable from both tray 12 and clamp 18 to allow support 10 to be broken down into the smallest possible units for compact storage.) As shown, lock nut 58 is positioned adjacent to socket member 32 so that, when tightened against socket member 32, the orientation of tray 12 relative to rod 16 is set. Further, lock nut 60 is located adjacent socket member 46 so that, when tightened against socket member 46, the orientation of clamp 18 relative to rod 16 is set.

The use of support 10 is straightforward with clamp 18 permitting secure attachment to pole 20 (or other suitable thing) regardless of the orientation of pole 20. First, support 10 is attached to pole 20 by utilizing fasteners 38 in a conventional manner to permit brackets 34 and 36 to be detached from one another and, then, reattached with pole 20 clamped therebetween. Then, the orientation of tray 12 is adjusted about the longitudinal axis of rod 16 as illustrated in FIG. 2 with tray 12 being rotated from its initial broken-line position to its final, horizontal, solid-line position. When tray 12 is in the final position, lock nuts 58 and 60 are brought to bear against socket members 32 and 46 to locking tray 12 in the final position. Now, by placing salt block 14 atop perforated panel 24, support 10 is ready to use in supplementing animals' dietary needs. When no longer needed, support 10 can be detached from post 20, disassembled, washed, and conveniently stored for subsequent reuse.

While support 10 has been described with a high degree of particularity, it will be appreciated by those skilled in the art that modifications can be made thereto. For example, socket members 32 and 46 could be integrally formed with walls 30 and 40 rather than being affixed thereto. Additionally, one end of rod 16 could be permanently attached, as by welding, to either tray 12 or clamp 18 to reduce the risk of rod 16 becoming lost while support 10 is being stored in a disassembled state. However, the support with the permanently attached rod could no longer be stored in as compact a configuration as that of support 10, a minor inconvenience for some users. Therefore, it is to be understood that the present invention is not limited to the sole embodiment described above, but encompasses any and all embodiments within the scope of the following claims.

1. A salt block support, comprising:
a tray for carrying a salt block;
a rod being secured to and extending from said tray, said rod having a longitudinal axis and a distal end being remote from said tray; and,
a clamp for attachment to a post, said clamp being secured to said distal end of said rod so as to rotate about said longitudinal axis relative to said tray.

2. The salt block support according to claim 1 wherein said tray includes:
a frame having a planar bottom wall with a central opening and a side wall extending upwardly from the periphery of said bottom wall; and,
a perforated panel positioned atop said bottom wall and covering said central opening.

3. The salt block support according to claim 1 wherein said clamp includes a pair of L-shaped brackets held in opposition to one another by a pair of threaded fasteners.

4. A salt block support, comprising:
a tray for carrying a salt block, said tray having a first internally threaded socket member affixed thereto;
a threaded rod being threadably secured to and extending from said first internally threaded socket member, said rod having a longitudinal axis and a distal end being remote from said tray; and,
a clamp for attachment to a post, said clamp having a second internally threaded socket member affixed thereto for threadably receiving said distal end of said threaded rod therein such that said clamp can rotate about said longitudinal axis relative to said tray.

5. The salt block support according to claim 4 further comprising a pair of lock nuts threadably positioned upon said threaded rod for bearing against said first and second internally threaded socket members for fixing the orientation of said tray and said clamp relative to said threaded rod.

6. The salt block support according to claim 4 wherein said tray further comprises:
a frame having a planar bottom wall with a central opening and a side wall extending upwardly from the periphery of said bottom wall, said side wall bearing said first internally threaded socket member; and,
a perforated panel positioned atop said bottom wall and covering said central opening.

7. The salt block support according to claim 4 wherein said clamp includes a pair of L-shaped brackets held in opposition to one another by a pair of threaded fasteners, and one of said L-shaped brackets bearing said second internally threaded socket member.

8. A salt block support, comprising:
a tray for carrying a salt block, said tray having a first internally threaded socket member affixed thereto;
a threaded rod being threadably secured to and extending from said first internally threaded socket member, said rod having a longitudinal axis and a distal end being remote from said tray; and,
a clamp for attachment to a post, said clamp including:
a first L-shaped bracket having a first pair of angularly joined walls defining a first post-receiving channel therebetween;
a first pair of apertured flanges, each being affixed to a respective one of said first pair of angularly joined walls;
a second internally threaded socket member being affixed to one of said first pair of angularly joined walls for threadably receiving therein said distal end of said threaded rod such that said clamp can rotate about said longitudinal axis relative to said tray;
a second L-shaped bracket being adjustably positioned adjacent said first L-shaped bracket, said second L-shaped bracket having a second pair of angularly joined walls defining a second post-receiving channel therebetween;
a second pair of apertured flanges, each being affixed to a respective one of said second pair of angularly joined walls; and,
a pair of threaded fasteners penetrating said first and second pair of apertured flanges so as to hold said first and second L-shaped brackets in opposition to one another; and,
a pair of lock nuts threadably positioned upon said threaded rod for bearing against said first and second internally threaded socket members for fixing the orientation of said tray and said clamp relative to said threaded rod.

9. The salt block support according to claim 8 wherein said tray further comprises:
a frame having a planar bottom wall with a central opening and a side wall extending upwardly from the periphery of said bottom wall, said side wall bearing said first internally threaded socket member; and,
a perforated panel positioned atop said bottom wall and covering said central opening.
